(19) United States
(12) Patent Application Publication
(10) Pub. No.: US 2009/0045937 A1
(43) Pub. Date: Feb. 19, 2009

(54) Hazard and Threat Assessment System

(76) Inventor: Larry Zimmerman, Stow, MA (US)

Correspondence Address: Gerald M. Bluhm;Tyco Safety Products, 50 Technology Drive, Westminster, MA, 01441-0001, US

(21) Appl. No.: 11/839,319

(22) Filed: Aug. 15, 2007

(51) Int. Cl. A62C 37/10

(52) U.S. Cl. 340/506; 169/60

(57) ABSTRACT

A fire alarm system for graphically illustrating a fire alarm event is provided. The fire alarm system may receive fire alarm information from one or more fire sensors in a building, and may determine a rate of change of at least one aspect of the fire sensor. The rate of increase of temperature, the length that the fire sensor has been activated, the progression of the fire, etc. The rate of change may be graphically illustrated to enable the operator to quickly assess the fire alarm event. A fire alarm system, whose actions are modified by the rate of change of the fire alarm event, is also provided. Depending on the rate of change, one or more input devices (e.g., cameras or other sensors) one or more output devices (e.g., sprinklers, notification appliances, etc.) in the fire alarm system may be controlled.

### BACKGROUND OF THE INVENTION

1. Technical Field

The present invention relates to a fire alarm system, and more particularly to a fire alarm system that may graphically portray a fire alarm event and that may provide recommendations to respond to or combat the fire alarm event.

2. Related Art

Fire alarm systems typically include one or more detectors in one or more areas of a building, monitoring the areas of the building for fire. If a fire or smoke occurs, the detectors send a signal to a central controller indicating that a fire or smoke is occurring. The central controller may then send a notification signal to various notification appliances in the building. These may include visual and/or audio notification. The central controller may also indicate the status of the fire alarm system to an operator or first responder to assist in evacuating the building. For example, the central controller may indicate to the operator or first responder (fireman, building guard, etc.) a list of the detectors that are sensing the fire. The operator or first responder may then provide an announcement to the occupants over the fire systems audio system or the buildings communications or mass notification systems to exit the building. Also, the central controller may activate a fire suppression system (such as a sprinkler system) in order to manage the fire.

Because the fire may spread quickly throughout the building, the occupants of the building should exit the building as quickly as possible. Any delay in exiting the building increases the possibility of injury or death for the occupants. Therefore, a need exists to assist the occupants to exit the building more quickly. Similarly, because the fire moves quickly, the central controller should direct the fire suppression system to control the fire as quickly as possible. Any delay subjects the building to more damage and the building's occupants to more injury. Therefore, another need exists for the fire suppression system to control the fire more quickly.

### SUMMARY OF THE INVENTION

A fire alarm system for graphically illustrating a fire alarm event is provided. The fire alarm system may receive fire alarm information from one or more fire sensors in a building. The fire sensors may sense any aspect of a fire and may include a smoke detector, carbon monoxide sensor, heat sensor, flame detector, etc. The controller in the fire alarm system receives the fire alarm information and determines a rate of change/duration of time of at least one aspect or sensed parameter of the fire sensor. For example, in determining the rate of change, the controller may determine the rate of increase of temperature, the progression of the fire, etc. If the sensor is a multiple detection device and collects smoke, heat, carbon monoxide, etc. it may receive multiple signals of detection. It may first sense carbon monoxide (CO), then smoke, and then heat. Other nearby sensors may detect CO and then smoke and also finally heat. From these data, the system may be able to display progression or increasing severity of the fire or related incident. As another example, in determining the duration of time, the controller may determine the duration or period of time that the fire sensor has been activated.

Further, the controller may combine these data and present them in a graphical means that illustrates the rate of change/duration of time of the fire sensor parameter. For example, a color, an icon, or a size of an icon may be selected based on the rate of change/duration of time of the fire sensor parameter. A display may then graphically illustrate the graphic illustration of the rate of change/duration of time of the sensor parameter and may also display these data from various sensors in various levels of their detection and also graphically illustrate the timing of when sensors made their detections. In this manner, the graphic illustrations of the rate of change/duration of time of the fire alarm event may assist the operator or first responder in quickly assessing the fire alarm event. The trend data and timing relationships among the sensors as they alarm, depicted by the graphical display, may assist the operator or first responder as to their decisions on how the fire or incident is migrating in the building and these data may assist them to access the fire and possible egress paths for occupants, ingress paths for first responders, and which and how the suppression systems or other fire management systems might be deployed.

A fire alarm system, whose actions are modified by the rate of change/duration of time of the fire alarm event, is also provided. For example, the controller may determine the rate of change of the fire alarm event, such as the directional indication by the timing sequence of sensor data, and may modify its operation based on the rate of change. Specifically, the controller may control one or more input devices (e.g., cameras or other sensors) in the fire alarm system based on the rate of change (e.g., directional indication by the timing sequence of sensor data) of the fire alarm event. For example, one or more cameras (or other sensors) may be commanded by the controller to turn on or to send its sensor data to the display for viewing. The controller may control one or more output devices (e.g., sprinklers, notification appliances, etc.) in the fire alarm system based on the rate of change of the fire alarm event. For example, progression (past, present or projected) of the fire to an area of the building may be determined based on the rate of change or directional indication by the timing sequence of sensor data of the fire alarm event. Sprinklers in the area may be activated in anticipation of the progression of the fire. As another example, a message (such as a warning to leave) may be generated for output on a notification appliance in the area of the building where the fire is progressing.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic diagram illustrating a system embodying the present invention.

FIG. 2 is a schematic diagram illustrating a simplified notification appliance circuit with two addressable notification appliances.

FIGS. 3A-B are a flow chart illustrating operation of the system controller in FIG. 1.

FIG. 4 is an example of a graphical illustration displaying the progression of the fire alarm event.

### DETAILED DESCRIPTION OF THE INVENTION

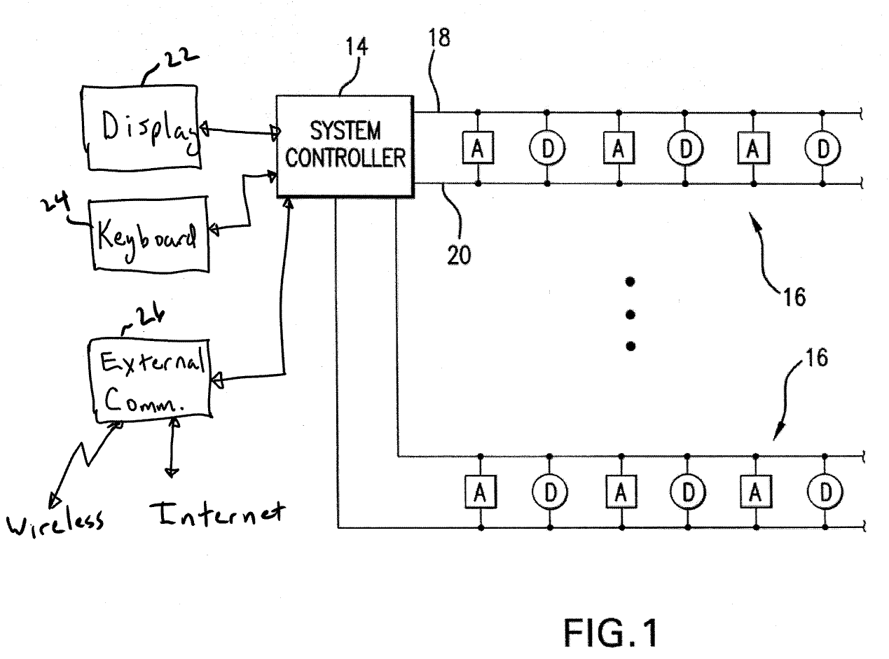

A system embodying the present invention is illustrated in FIG. 1. The system includes one or more notification appliance circuits (NACs), i.e., networks 16, having alarm condition detectors D and alarm notification appliances A. Alternatively, the detectors and notification appliances may be on separate networks. The detectors D may detect any aspect of a fire, such as smoke, temperature, or any combination thereof. The detectors D may be monitored by a system controller 14, as discussed in more detail below. The detectors D may periodically send a status signal indicating the status of the respective detector D. Further, the detectors D may detect the aspect related to the fire, and may determine whether to issue an alarm message to the system controller 14. For example, if smoke is detected (such as smoke detected above a predetermined amount), the detector D may send a signal to the system controller 14 indicating that smoke has been detected, indicating an alarm condition. When an alarm condition is sensed, the system controller 14 may signal the alarm to the appropriate notification appliances through one or more networks 16. Notification appliances may include, for example, a visual alarm (strobe), an audible alarm (horn), a speaker, or a combination thereof.

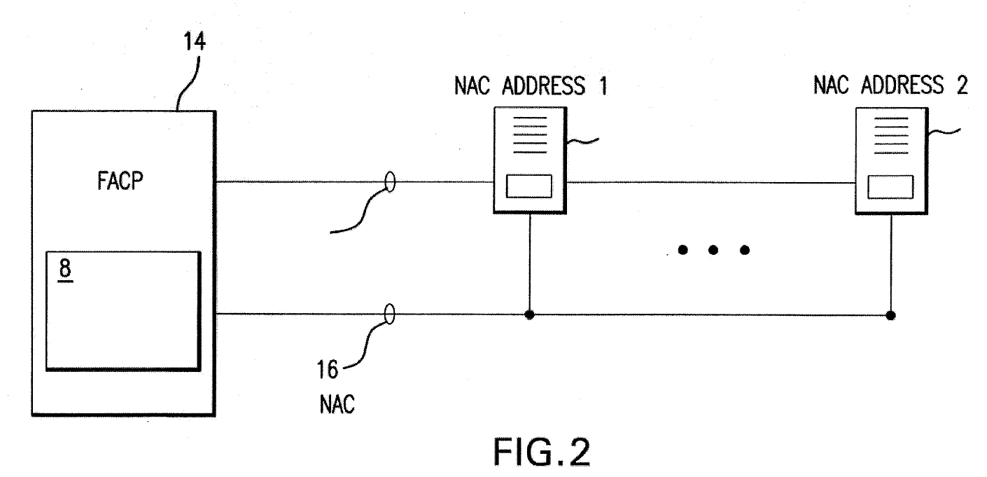

Although not necessary for carrying out the invention, as shown, all of the notification appliances in a network are coupled across a pair of power lines 18 and 20 that advantageously also carry communications between the system controller 14 and the notification appliances A. The audio signal may be generally carried to appliances with speakers over a separate circuit (described below with reference to FIG. 2).

The fire alarm system may further include a keyboard or similar operator input device 24 and a display 22 or similar output device. The keyboard 24 and the display 22 may communicate with the system controller 14. Specifically, commands may be input via the keyboard 24 in order to control the system controller 14. Further, the display 22 may comprise a touch display. The system controller 14 may select one or more graphic illustrations for display on the display 22, as discussed in more detail below.

FIG. 2 is a schematic diagram showing a simplified notification appliance circuit 16 with two addressable smart speakers 33. An example of an addressable smart speaker is disclosed in U.S. Pat. No. 7,170,396, which is incorporated by reference herein in its entirety. Each speaker 33 may be assigned a unique address, in this example 1 and 2 respectively. The speakers 33 may communicate with a system controller 14, or fire alarm control panel (FACP), via a notification appliance circuit 16. A separate speaker circuit 31 may provide an audio signal to the speakers 33. Software 8 within the system controller 14 may address the individual speakers, for example, to provide commands to the speakers, such as configuration commands (e.g., to set speaker taps) or such as output commands (e.g., a command to output a message on the speakers).

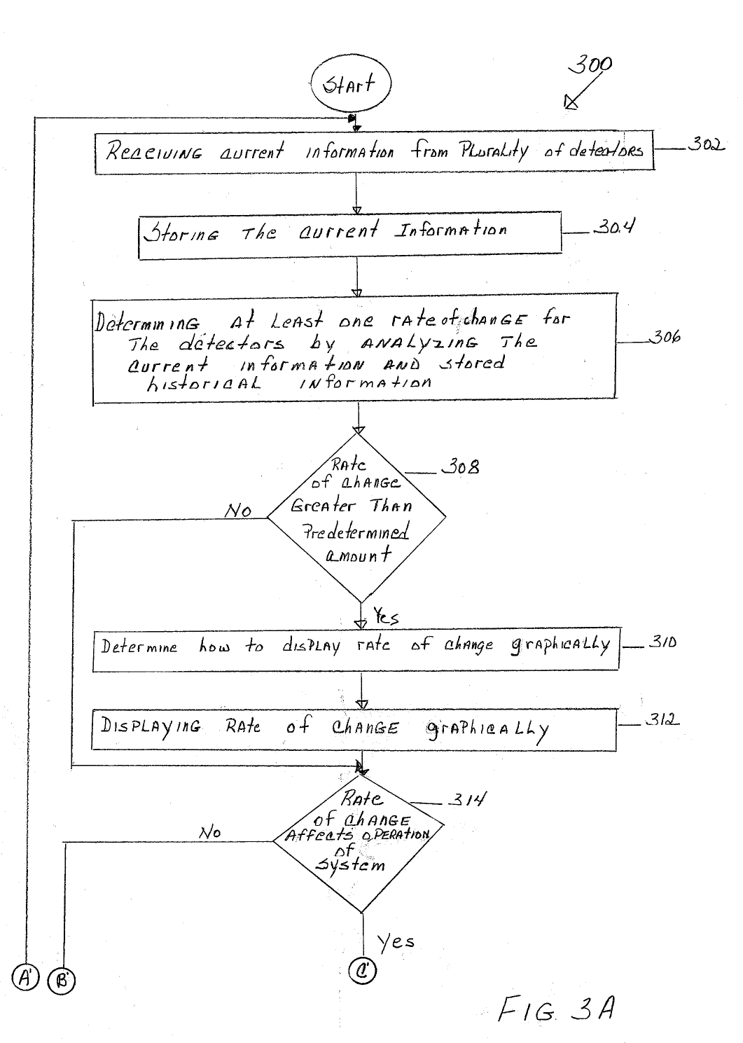

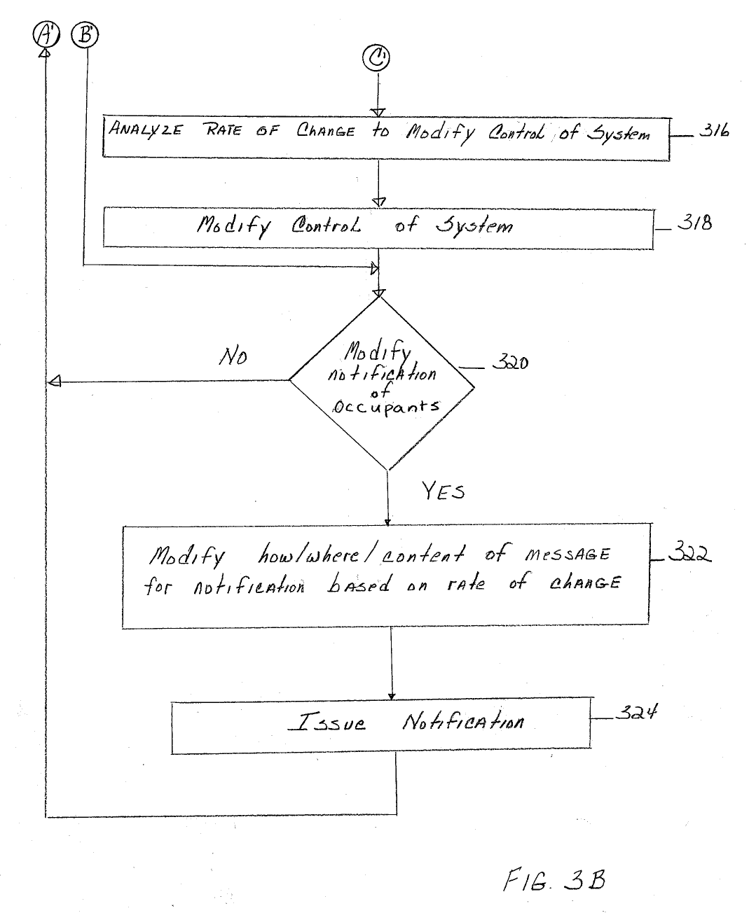

FIGS. 3A-B are a flow chart 300 illustrating operation of the system controller in FIG. 1. Current information is received by the system controller from one or more of detectors, as shown at block 302. As discussed above, the detectors may detect any aspect related to a fire. The current information may be stored in a database, as shown at block 304. The system controller then determines the rate of change of at least one aspect of the detector D, as shown at block 306. The rate of change may comprise any aspect of the detector D (or combination of detectors D) that relates to the fire alarm event. For example, the rate of change may include a rate of temperature change as detected by the detector D. As still another example, the rate of change may be a rate of change of one detector D relative to another detector D (e.g., which of two or more detectors is changing its sensed values quicker). Still another example is the rate of change may comprise a progression of the fire alarm event (e.g., the data from one or more detectors D may be used to determine at least one of path and velocity of the fire alarm event). The system controller may also determine the duration of at least one aspect of the detector D. For example, the duration may include a time period during which the detector has sent a signal indicating an alarm condition.

As shown in FIGS. 3A-B, the system controller 14 may execute a loop whereby information from the detectors D is periodically stored in the database. In order to determine the rate of change, the system controller 14 may analyze both the current information from the detectors D and stored historical information from the detectors D. The rate of change may comprise a difference between the current information from the detectors D and the most recently stored historical information. Or, additional historical entries may be used to determine the rate of change.

The rate of change may be analyzed to determine if it is greater than a predetermined amount, as shown at block 308. In the example of a temperature rate of change, the rate of change may be analyzed to determine whether it is greater than a predetermined amount. If this is the case, the system controller 14 may determine that the temperature is increasing too greatly, indicating rapid progression of the fire. Or, the rate of change may be analyzed to determine a progression of the fire alarm event.

In the event the rate of change is greater than a predetermined amount, the system controller 14 may determine how to display the rate of change graphically, as shown at block 310, and the rate of change may be displayed graphically, as shown at block 312. The display 22 may solely display the graphic illustration, or may illustrate positions of the sensors in the building and correlate the graphic illustration of the rate of change with positions of at least some of the sensors in the building. For example, the display 22 may illustrate the positions of the detectors D using icons, and the display 22 may further correlate the graphic illustration of the rate of change with the positions of the detectors D.

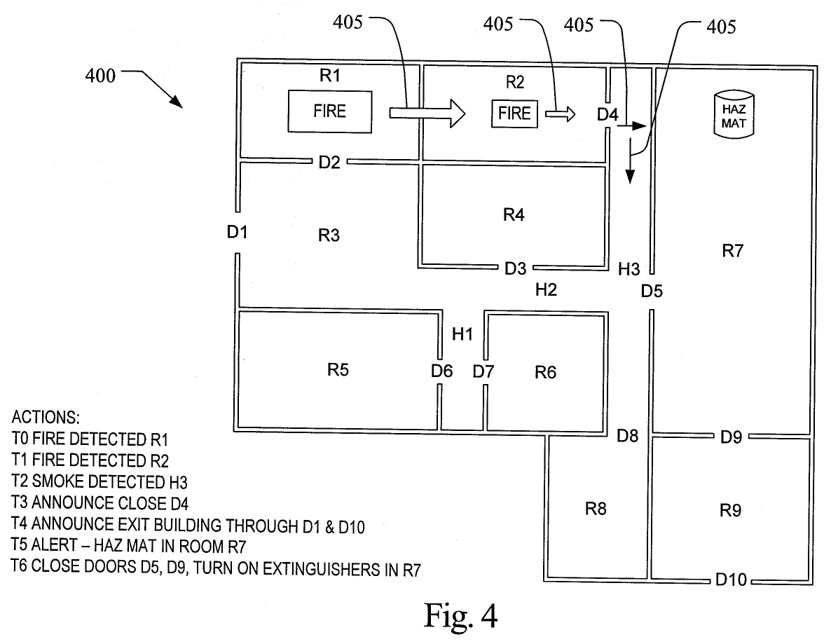

There are several ways in which to display the rate of change graphically. For example, the system controller 14 may select a color based on the rate of change, such as a color of an icon (e.g. a smoke detector) indicating the rate of change. Specifically, a color of red may indicate a rapid rate of change. As another example, the rate of change may be graphically displayed by the icon selected. As still another example, the size of the icon (or other graphic illustration) may be selected based on the rate of change. Specifically, a larger icon may be selected to indicate a greater rate of change. For example, when graphically illustrating the progression of the fire alarm event, an arrow may be used to indicate the path of the progression and the size of the arrow may indicate the velocity of the progression. The arrow may be displayed in combination with another graphic, such as an illustration of potentially hazardous material stored in the building, as shown in FIG. 4 (discussed in more detail below). The information regarding the potentially hazardous material may be stored in a database. In this manner, an operator may quickly determine whether there is any immediate danger based on the graphic illustrations of the progression and the hazardous material located in the building.

The system controller 14 may examine the rate of change to determine whether to modify or affect operation of another aspect of the fire alarm system, as shown at block 314. If so, the rate of change may be analyzed to determine whether to modify control of the system, as shown at block 316, and to modify control of the system, as shown at block 318. Depending on the determined rate of change, the system controller 14 may access stored procedures to be followed to mitigate the fire alarm event, and may take actions or provide a display to illustrate the stored procedures. For example, the system controller 14 may control the sprinklers (or other fire suppression devices) based on the determined rate of change. Specifically, the information from the detectors D may be used to determine progression of the fire alarm event (e.g., depending on the rate of change of one or more sensors, a projected direction of the fire to another area of the building may be determined). Based on the determined progression, the system controller may activate the sprinklers in advance of (or concurrently with) the detectors D in the area sensing an alarm condition. As another example, the system controller 14 may control one or more sensor inputs (such as still or video cameras) based on the determined rate of change. As discussed above, the progression of the fire alarm event may be determined. Cameras in the area of the determined progression may be activated (if not already on). Further, the display 22 may automatically display the output of the camera, or may display a link to the camera. In this way, the operator may activate the link, such as by touching the display 22.

The rate of change may be used to determine whether to modify notification of the occupants, as shown at block 320. If so, the system controller 14 may determine how to modify the notification, where the notification should be applied or annunciated, and/or the content of the message for the notification based on the rate of change, as shown at block 322, and may issue the notification, as shown at block 324. For example, the system controller 14 may control one or more of the notification appliances A based on the rate of change. As discussed above, the system controller 14 may determine the progression of the fire alarm event. Based on the determined progression, the system controller 14 may generate a message to the area where the fire currently is and/or the area to which fire is projected to progress, indicating that those in these areas should exit immediately, and may send the message to the notification appliances A in the areas.

FIG. 4 is an example of a graphical illustration 400 displaying the progression of the fire alarm event. In the illustration, rooms are designated as R1-R9, doorways are designated as D1-D10, hallways are designated as H1-H3. At time=T0, fire is detected in room R1. At time=T1, fire is detected in room R2. At time=T2, smoke is detected in H3. At time=T3, an announcement is made that door D4 is being closed, and door D4 is closed. At time=T4, an announcement is made to exit the building through doorways D1 and D10. At time=T5, an alert is given that hazardous materials (depicted as HAZ MAT in FIG. 4) are in room R7. At time=T6, doors D5 and D9 are closed, and the fire suppression device (such as a fire extinguisher) is turned on in room R7.

As shown in FIG. 4, the progression of the fire (such as in which areas the fire has been detected) may be depicted by arrows 405. Further, the arrows 405 may be of different size in order to depict how long the fire has been resident in a particular area and/or how high the temperature is in a particular area. Alternatively, the predicted progression of the fire may be depicted by arrows 405.

Further, icons or words/graphics may be used to indicate the intensity of the fire and/or the duration of the fire. For example, FIG. 4 depicts “FIRE” in rooms R1 and R2. The intensity of the fire (such as the temperature) and/or the duration of the fire (such as from when the fire was first detected) may be illustrated by selection of a color for the word “FIRE” and/or selection of graphics that accompany the word “FIRE” (such as the number of rectangles around the word “FIRE” indicating the intensity and/or duration, with a greater number of rectangles indicating a greater intensity or duration).

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A fire alarm monitoring system comprising:
a receiver adapted to receive fire alarm information from a plurality of fire sensors in a building, the fire alarm information indicative of a fire alarm event;
a controller in communication with the receiver for determining a rate of change or a duration of at least one aspect of the fire alarm event and for determining a graphical illustration to graphically illustrate the rate of change or the duration; and
a display in communication with the controller, the display adapted to graphically illustrate the graphic illustration of the rate of change or the duration of the at least one aspect of the fire alarm event.

2. The fire alarm monitoring system of claim 1, wherein the controller determines for at least one of the plurality of fire sensors a time period during which the sensor provided information indicative of the fire alarm event;
wherein the duration comprises the time period during which the at least one of the plurality of fire sensors has sent a signal indicating an alarm condition; and
wherein the display is adapted to graphically illustrate the time period of at least one of the plurality of sensors.

3. The fire alarm monitoring system of claim 1, wherein the rate of change comprises a rate of increase of temperature; and
wherein the display is adapted to graphically illustrate the rate of increase of the temperature of at least one of the plurality of sensors.

4. The fire alarm monitoring system of claim 1, wherein the rate of change comprises a progression of the fire alarm event;
wherein the controller determines the progression of the fire alarm event; and
wherein the display is adapted to graphically illustrate the progression of the fire alarm event.

5. The fire alarm monitoring system of claim 1, wherein the controller selects a color from a plurality of colors to indicate the rate of change or the duration of the fire alarm event; and
wherein the display is adapted to graphically illustrates the rate of change or the duration based on the color selected.

6. The fire alarm monitoring system of claim 1, wherein the controller selects a size of an icon to indicate the rate of change or the duration of the fire alarm event; and
wherein the display is adapted to graphically illustrates the selected icon.

7. The fire alarm monitoring system of claim 1, wherein the display is further adapted to illustrate positions of the sensors in the building and to correlate the graphic illustration of the rate of change or the duration with positions of at least some of the sensors in the building.

8. The fire alarm monitoring system of claim 7, wherein the display illustrates positions of the sensors in the building using icons; and
wherein the display correlates the graphic illustration of the rate of change or the duration with positions of at least some of the sensors.

9. The fire alarm monitoring system of claim 7, wherein the plurality of sensors comprise any or all of: smoke detectors, fire detectors, heat detectors, flame detectors, and carbon monoxide detectors.

10. The fire alarm monitoring system of claim 1, wherein the controller uses the fire alarm information to generate at least one of path and velocity of the fire alarm event; and
wherein the display is adapted to graphically illustrate at least one of the path and the velocity of the fire alarm event.

11. The fire alarm monitoring system of claim 1, wherein the controller uses the fire alarm information to determine progression of the fire alarm event; and
wherein the display is adapted to graphically illustrate projected progression of the fire alarm event.

12. The fire alarm monitoring system of claim 11, wherein the controller commands an action responsive to the determined progression.

13. The fire alarm monitoring system of claim 12, the action being at least one of: turning on a sprinkler system, turning on a camera in the vicinity of an alarm, and turning on a camera in an area of predicted fire progression.

14. The fire alarm monitoring system of claim 11, wherein the controller predicts future trouble areas based on the determined progression of the fire alarm event; and
wherein the controller actuates at least one notification alarm to direct occupants along a particular evacuation route away from the predicted future trouble spots.

15. The fire alarm monitoring system of claim 11, wherein the controller indicates whether fire is advancing toward hazardous material stored in the building.

16. The fire alarm monitoring system of claim 11, wherein the controller, responsive to indicated events, accesses stored procedures to be followed to mitigate the fire alarm event; and
wherein the display is adapted to illustrate the stored procedures.

17. The fire alarm monitoring system of claim 1, wherein the display comprises a touchscreen for user input.

18. A fire alarm system comprising:
a plurality of sprinklers;
a plurality of cameras;
a plurality of notification appliances;
a plurality of fire sensors; and
a controller in communication with the sprinklers, the cameras, the notification appliances, and the fire sensors, the controller comprising logic for:
receiving fire alarm information from the fire sensors indicative of a fire alarm event;
determining a rate of change of at least one aspect of the fire alarm event based on the fire alarm information and previous fire alarm information;
determining progression of the fire alarm event based on the rate of change;
selecting at least one of the sprinklers, cameras, or notification appliances based on the progression of the fire alarm event; and
controlling at least one of the sprinklers, cameras or notification appliances based on the determined progression of the fire alarm event.

19. The fire alarm system of claim 18, wherein the logic for determining the progression of the fire alarm event comprises logic for determining an area to which the fire alarm event is projected to progress; and
wherein the logic for controlling at least one of the sprinklers, cameras or notification appliances comprises controlling at least one sprinkler in the area.

20. The fire alarm system of claim 18, wherein the logic for determining the progression of the fire alarm event comprises logic for determining an area where the fire alarm event is projected to progress; and
wherein the logic for selecting at least one of the sprinklers, cameras, or notification appliances based on the progression of the fire alarm event comprises logic for selecting at least one notification appliance based on the determined area.

21. The fire alarm system of claim 20, wherein the at least one selected notification appliance is located in or proximate to the determined area; and
wherein the controller further comprising logic for generating a message indicating progression of the fire to the area and for sending the message to the at least one notification appliance selected.

22. The fire alarm system of claim 18, wherein the logic for determining the progression of the fire alarm event comprises logic for determining an area where the fire alarm event will progress; and
wherein the logic for selecting at least one of the sprinklers, cameras, or notification appliances based on the progression of the fire alarm event comprises logic for selecting at least one camera based on the determined area.

23. The fire alarm system of claim 22, wherein the at least one camera selected is located in or proximate to the determined area; and
wherein the controller further comprising logic for sending to a display an image or a link to the image from the selected camera.

24. A method for displaying information regarding a fire alarm event, the method comprising:
receiving fire alarm information from a plurality of fire sensors in a building, the fire alarm information indicative of a fire alarm event;
determining a rate of change or a duration of at least one aspect of the fire alarm event;
determining a graphical illustration to graphically illustrate the rate of change or the duration; and
graphically illustrating the graphic illustration of the rate of change or the duration of the at least one aspect of the fire alarm event.

25. The method of claim 24, wherein determining a rate of change or a duration comprises determining for at least one of the plurality of fire sensors a time period during which the sensor provided information indicative of the fire alarm event; and
wherein the display is adapted to graphically illustrate the time period of at least one of the plurality of sensors.

26. The method of claim 24, wherein the rate of change comprises a rate of increase of temperature; and
wherein graphically illustrating comprises graphically illustrating the rate of increase of the temperature of at least one of the plurality of sensors.

27. The method of claim 24, wherein the rate of change comprises a progression of the fire alarm event;
wherein determining a rate of change or a duration of at least one aspect of the fire alarm event comprises determining the progression of the fire alarm event; and
wherein graphically illustrating comprises graphically illustrating the progression of the fire alarm event.
